(19) United States
(12) Patent Application Publication
(10) Pub. No.: US 2009/0319484 A1
(43) Pub. Date: Dec. 24, 2009

(54) Using Web Feed Information in Information Retrieval

(76) Inventors: Nadav Golbandi, Karkur (IL); Naama Kraus, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/143,855

(22) Filed: Jun. 23, 2008

(51) Int. Cl. G06F 17/30

(52) U.S. Cl. 707/3; 707/10; 707/E17.108; 707/E17.01

(57) ABSTRACT

A method and system for using web feed information are provided in which web feed information is obtained relating to a resource referenced in a web feed, wherein web feed information includes at least one of: content of a web feed entry, metadata of a web feed, and information relating to a web feed. The web feed information may include content of a web feed entry such as a link to a resource, description of a resource, and metadata of a resource. The web feed information may also include information relating to a web feed such as metadata of the web feed itself, subscribers to the web feed, topic hierarchy of resources referenced in web feeds, web feed popularity, and resources linked by references in the same web feed. The web feed information relating to the resource is provided for access by a search engine. In order to enhance search engine capabilities and thus provide users with an improved search quality and experience.

### FIELD OF THE INVENTION

This invention relates to the field of information retrieval. In particular, the invention relates to using web feed information to enhance information retrieval.

### BACKGROUND OF THE INVENTION

A web search engine is designed to search for information on the World Wide Web. Information may consist of web pages, images and other types of files. Some search engines also mine data available in newsgroups, databases, or open directories. Search engines provide retrieval capabilities to users by various methods and from various information sources. Examples of information sources include document content, anchor text, document metadata, and so on.

A web feed (also known as a syndicated feed) is a data format used for providing users with frequently updated content. The purpose of a web feed is to allow content providers (such as website owners) to push information to content consumers. Web feeds are operated by many news websites, weblogs, schools, and pod casters. Content distributors syndicate a web feed, thereby allowing users to subscribe to it.

In the typical scenario of using web feeds, a content provider publishes a feed link on their site which end users can register with an aggregator program (also called a feed reader or a news reader) running on their own machines.

The kinds of content delivered by a web feed are typically HTML (hypertext markup language) documents providing web page content, or links to web pages and other kinds of digital media. Often when websites provide web feeds to notify users of content updates, they only include summaries in the web feed rather than the full content itself.

Web feeds contain rich information about the resources they relate to or link to which is not currently used by search engines when retrieving information.

It is an aim of the present invention to provide information from web feeds for use by search engines when indexing resources, which enhances retrieval abilities over existing solutions.

### SUMMARY OF THE INVENTION

According to a first aspect of the present invention there is provided a method for using web feed information, comprising: obtaining web feed information relating to a resource referenced in a web feed, wherein web feed information includes at least one of: content of a web feed entry, and information relating to a web feed; and providing the web feed information relating to the resource for access by a search engine.

Optimally, a search engine uses the web feed information relating to the resource to enhance search retrieval. A search engine may apply the web feed information to enrich a resource's representation in a search engine index.

The content of a web feed entry may include one or more of the group of: a link to a resource, a description of a resource, metadata of a resource. Information relating to a web feed may include one or more of the group of: metadata of a web feed containing a web feed entry, subscribers to a web feed, web feed popularity, topic hierarchy of resources referenced in web feeds, and resources linked by references in the same web feed. Metadata of a web feed may include one or more of the group of: a web feed title, web feed author, web feed date, and category of a web feed, or other types of metadata which may be included in a web feed.

Obtaining web feed information may include extracting the web feed information from a web feed and/or obtaining the web feed information from a web feed reader.

In one embodiment, obtaining web feed information includes crawling web feeds and providing the web feed information for access by a search engine includes indexing the web feed information in a search engine index.

Providing the web feed information may include enriching a resource with the web feed information for indexing in a search engine. Enriching a resource with the web feed information may include one or more of the group of: adding fields to the resource, adding facets to the resource, providing static scores, appending content to original resource content, or other methods of enriching a resource.

Providing the web feed information may include providing the web feed information for access by a search engine when indexing resources and/or when processing search query results.

The method may include combining web feed information from different web feed entries relating to the same resource.

According to a second aspect of the present invention there is provided a computer software product for using web feed information, the product comprising a computer-readable storage medium, storing a computer in which program comprising computer-executable instructions are stored, which instructions, when read executed by a computer, perform the following steps: obtaining web feed information relating to a resource referenced in a web feed, wherein web feed information includes at least one of: content of a web feed entry, and information relating to a web feed; and providing the web feed information relating to the resource for access by a search engine.

According to a third aspect of the present invention there is provided a method of providing a service to a customer over a network, the service comprising: obtaining web feed information relating to a resource referenced in a web feed, wherein web feed information includes at least one of: content of a web feed entry, and information relating to a web feed; and providing the web feed information relating to the resource for access by a search engine.

According to a fourth aspect of the present invention there is provided a system for using web feed information, comprising: a processor; means for obtaining web feed information relating to a resource referenced in a web feed, wherein web feed information includes at least one of: content of a web feed entry, and information relating to a web feed; and means for providing the web feed information relating to the resource for access by a search engine.

A search engine may use the web feed information relating to the resource to enhance search retrieval by applying the web feed information to enrich a resource's representation in a search engine index.

The means for obtaining web feed information may include means for extracting the web feed information from a web feed entry and/or means for obtaining the web feed information from a web feed reader. The means for obtaining web feed information may be a search engine crawler and the means for providing the web feed information may be a search engine index or a search engine push interface.

The means for providing the web feed information may include: means for enriching a resource with the web feed information; and an interface for indexing the enriched resource in a search engine. The means for enriching a resource with the web feed information may include one or more of the group of: adding fields to the resource, adding facets to the resource, providing static scores, appending content to original resource content, or other methods of enriching a resource.

The means for providing the web feed information may include: an interface for providing the web feed information for access by a search engine when indexing resources and/or when processing search query results.

The system may include a means for combining web feed information from different web feed entries relating to the same resource.

According to a fifth aspect of the present invention there is provided a method for using web feed information, comprising: obtaining web feed information relating to a resource referenced in a web feed, wherein web feed information includes at least one of: content of a web feed entry, and information relating to a web feed; applying the web feed information to enrich a resource's representation in a search index.

According to a sixth aspect of the present invention here is provided a search engine comprising: means for obtaining web feed information relating to a resource referenced in a web feed, wherein web feed information includes at least one of: content of a web feed entry, and information relating to a web feed; and a profiling module applying the web feed information to enrich a resource's representation in a search index.

The existence of web feeds as resource descriptors is exploited and extra information is deduced on the referenced resources. Web feed information is applied to referenced documents to extend document representation. The additional information may be used by search engines to enhance the search services provided by them.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of an information retrieval system as known in the prior art;

FIG. 2 is a block diagram of a search system as known in the prior art;

FIG. 3 is a schematic diagram showing information available in and associated with a web feed as used in accordance with the present invention;

FIG. 4 is a block diagram of an information retrieval system in accordance with a first embodiment of an aspect of the present invention;

FIG. 5 is a block diagram of an information retrieval system in accordance with a second embodiment of an aspect of the present invention;

FIGS. 6A and 6B are block diagram of two further embodiments of information retrieval systems in accordance with aspects of the present invention;

FIG. 7 is a flow diagram of a first method in accordance with an aspect of the present invention;

FIG. 8 is a flow diagram of a second method in accordance with an aspect of the present invention;

FIGS. 9A and 9B are flow diagrams of further methods in accordance with aspects of the present invention; and

FIG. 10 is a block diagram of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

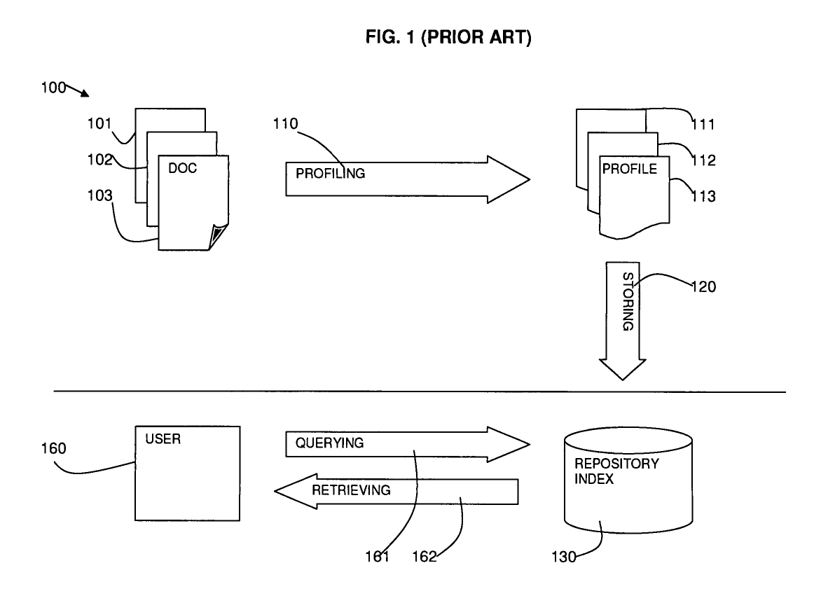

Referring to FIG. 1, a schematic diagram shows the flow 100 of a typical information retrieval system.

The inputs to the system are documents 101-103, which are fetched to be indexed by a crawling mechanism (not shown). A profiling (pre-processing) step 110 prepares documents 101-103 for indexing by generating profiles 111-113 of the documents 101-103. In this stage, the documents 101-103 go through various text analysis operations such as tokenization, stemming, annotating, and more. The profiles 110-113 are stored 120 in a repository index 130. This processing shown in the top section of the figure is referred to as indexing.

A retrieval stage shown in the bottom section of the figure is carried out by a user 160 querying 161 and retrieving 162 ranked documents from the repository index 140.

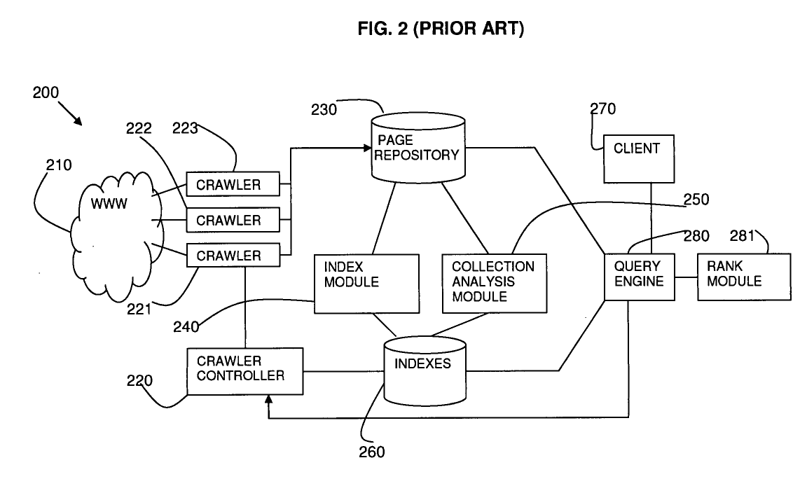

Referring to FIG. 2, an embodiment of an information retrieval system in the form of a search engine 200 is shown as known in the prior art.

A search engine 200 fetches documents to be indexed from the World Wide Web 210, or from resources on an intranet. The search engine 200 includes a crawl controller 220 which controls multiple crawler applications 221-223 which fetch documents which are stored in a page repository 230.

The documents stored in the page repository 230 are profiled by a collection analysis module 250 and indexed by an index module 240. Indexes 260 are maintained with text, structure, and utility information of the documents.

A client 270 can input a query to a query engine 280 which retrieves relevant documents from the page repository 230. The query engine 280 may include a ranking module 281 for ranking returned documents. The returned documents are provided as results to the client 270. User feedback from the query engine 280 may be provided to the crawl controller 220 to influence the crawling.

The following characteristics of a web feed may be observed:
A web feed contains a group of entries, each of which describes a resource in a condensed manner, including resource metadata.
A web feed defines a topic of interest, thus all entries in the web feed indicate resources belonging to a common topic.
Content owners update a web feed with new entries, which identify recent and important resources.
Each web feed has a set of users that are subscribed to it, indicating users that have interest in that feed.

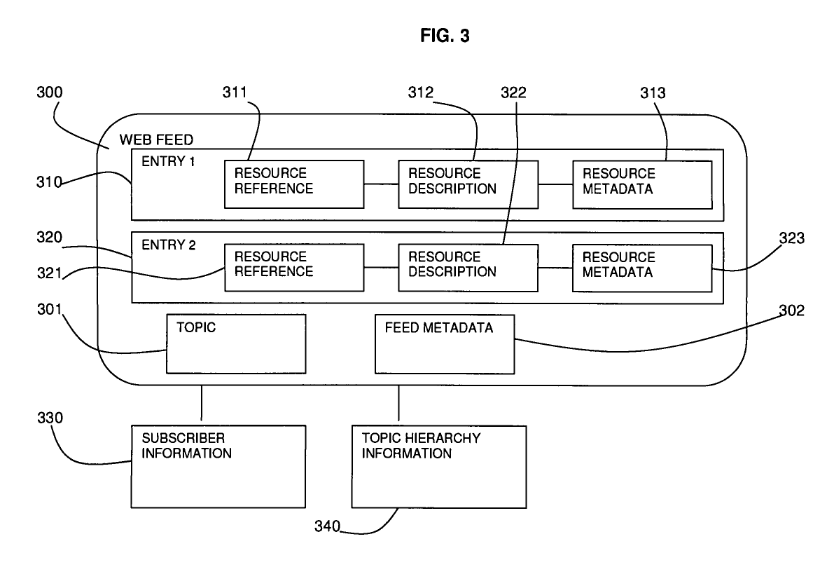

Referring to FIG. 3, a schematic diagram shows a web feed 300 and the information that it includes or is associated with it. A web feed 300 includes one or more feed entries 310, 320, each containing a resource reference 311, 321, for example, a reference to a document such as a web page, blog, etc. Each of the resource references 311, 321 has a resource description 312, 322 and resource metadata 313, 323. The resource metadata 313, 323 may include the publication date, author, categories, etc.

The web feed 300 includes a topic 301 to which all the feed entries 310, 320 relate. The web feed 300 also includes feed metadata 302 which is the metadata relating to the feed itself.

In addition, further information is associated with or can be determined from the web feed 300. Subscriber information 330 is associated with a web feed 300 and includes all the subscribers which pull information from the web feed 300. Topic information 301 appears inside the web feed, and topic hierarchy (taxonomy) information 340 may be deduced by any component.

The described systems and methods use the information provided in or associated with web feeds relating to referenced resources to enhance information retrieval from resources.

In a first embodiment of a described system, enhancing of referenced resources is carried out in the profiling stage of information retrieval. The creation of document profiles includes enriching the documents information appearing in the web feeds referring to them.

Search engine crawlers are responsible for crawling a resource corpus once in a while (usually at configurable intervals) and fetching fresh documents for indexing. In the described system, the crawler crawls web feeds along with the documents they refer to. Upon profiling, a collection analysis module of a search engine pre-processes the documents as usual, with the addition of the information from the web feeds.

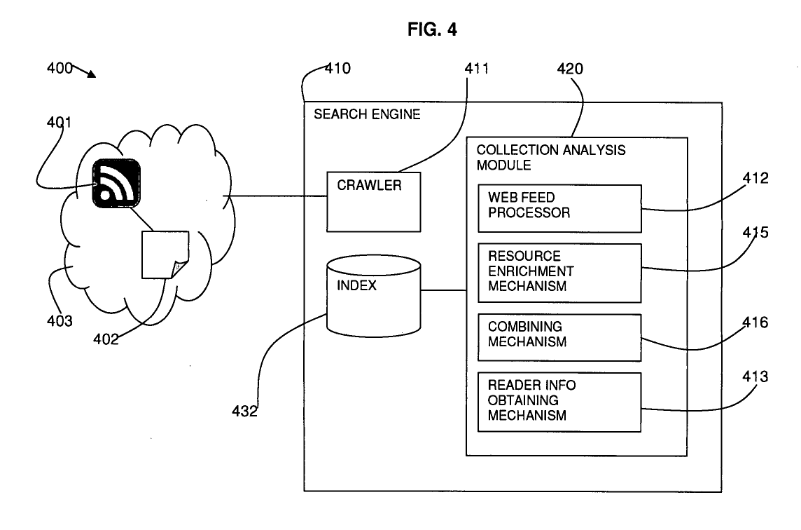

Referring to FIG. 4, an information retrieval system 400 is shown having a search engine 410. Web feeds 401 and resources 402 in a corpus 403, such as the World Wide Web or an intranet, are crawled by a crawler 411 of the search engine 410. A collection analysis module 420 (or profiling module) of the search engine 410 includes a web feed processor 412 for processing web feed information and a resource enrichment mechanism 415 for enriching resources by adding the web feed information to document profiles in the search engine's index 432.

A combining mechanism 416 may also be provided in the collection analysis module 420, so that if multiple feed entries reference the same resource, an aggregation of the metadata contributed by each one of them will be generated and applied to the referenced resource.

The collection analysis module 420 may optionally also include a reader information obtaining mechanism 413 for obtaining information relating to web feeds from a web feed reader. The information obtained from a web feed reader may include subscription information and deduced web feed popularity information. A topic hierarchy (taxonomy) may be deduced by the collection analysis module 420, or alternatively, in a web feed reader.

A second embodiment of a described system is provided as a separate component from a search engine and acts in conjunction with a central web feed reader.

Conventional web feed readers, also known as feed aggregators, news readers, or simply as aggregators, aggregate syndicated web content from resources such as news headlines, blogs, podcasts, and vlogs in a single location for easy viewing. Aggregators reduce the time and effort needed to regularly check websites for updates, creating a unique information space for a user. Once subscribed to a feed, an aggregator is able to check for new content at user-determined intervals and retrieve the update. The content is sometimes described as being “pulled” by the reader on behalf of the subscriber, as opposed to “pushed” with email or instant messaging.

Web feed readers serving multiple clients (which may also be referred to as a central feed reader/aggregator/syndication service) get web feeds on behalf of multiple clients concurrently. Such web feed readers may be provided on a web application server. Client applications subscribe to a feed, get popular feed information, get feed's posts, register feeds, etc via an API (application programming interface) of the web feed reader or using a Graphical User Interface (GUI). A central feed reader may implement a feed update notification service which notifies subscribers upon feed updates. Feed updates are sent by the web feed reader to the client application. Alternatively, a feed reader may provide an API for clients to get feed latest posts upon request. A feed reader may support both mechanisms.

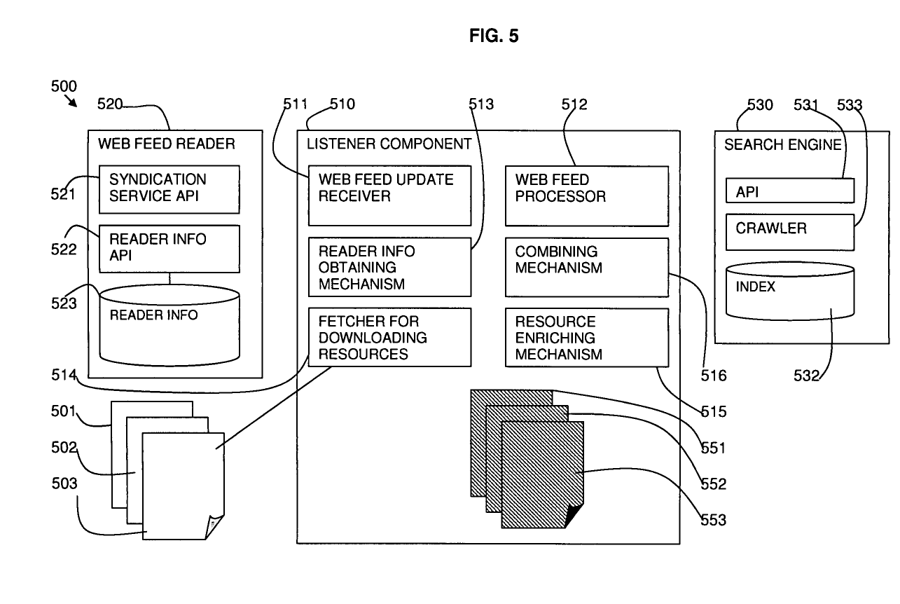

Referring to FIG. 5, a web feed reader 520 is shown in an information retrieval system 500 as including a syndication service API 521 for syndicating web feeds to subscribers. The web feed reader 520 also includes a reader information API 522 and a database 523 for storing reader information relating to web feeds which is used or collected by the web feed reader 520 such as subscriber information, feed popularity information, etc.

The described system 500 includes a listener component 510 provided in communication with a web feed reader 520. The listener component 510 is a special purpose client of the web feed reader 520. The listener component 510 subscribes to feeds which are of interest to be used for enrichment, probably defined by an administrator (e.g. the search engine administrator or site content administrator), and includes a web feed update receiver 511 to get feed update notifications upon any feed update event. The listener component 510 includes a fetcher 514 which fetches the documents 501-503 referenced by the update events.

In addition, the listener component 510 includes a reader information obtaining mechanism 513 for obtaining web feed reader information not available in the web feeds themselves, but available from the web feed reader 520 database 523. The reader information may include subscriber information, topic hierarchy information, and web feed popularity. The reader information is obtained from the web feed reader 520 using a reader information API 522 exposed by the web feed reader 510. The web feed reader 510 maintains an internal database 523 in which is stores the reader information.

In one version, the information gathered by the listener component 510 in the form of the web feeds referencing the resources, the downloaded resources, and the reader information are handed over to a search engine 530 which uses the information to enrich the resource representation (profile) in the index 532 of the search engine 530. This may be done using a search engine push API 531 which allows an external software module to push documents into the index as opposed to using crawling services. Alternatively, the information will be consumed later by a search engine crawler 533. In the latter case, the listener component 510 stores the data until it is consumed.

Push is usually done when one is interested in having the index as up-to-date as possible, thus changes to the data are almost immediately reflected in the index. Crawling updates the index only once in a while. The index supports an incremental update mechanism to allow this behaviour.

In an alternative version, the listener component 510 provides more of the enrichment process. The listener component 510 includes a web feed information extractor 512 for extracting information and metadata from a web feed. The listener component 510 may also include a resource enriching mechanism 515 for enriching the downloaded documents with information either as extracted from the new web feed entries, and/or as obtained from the web feed reader 520 to result in enriched resources 551-553. The enriched resources 551-553 may include the information using additional text, fields, or facets, static scores or by simply appending content to the original document content.

A combining mechanism 516 may also be provided, so that if multiple feed entries reference the same resource, an aggregation of the metadata contributed by each one of them will be generated and applied to the referenced resource.

The listener component 510 may use a search engine API 531 to index the enriched resources 551-553 enriched with web feed information to the search engine's index 532 using index push API. Alternatively, the data may be consumed at a later point by the search engine crawler 533. In the latter case, the listener component 510 stores the data until it is consumed.

A central web feed reader may optionally be used independently for providing web feed reader information which does not exist in the web feeds themselves. This is primarily subscription information and information stemming from it, like feed popularity.

A web feed reader 620 maintains an internal database 621 in which it stores subscription information 622 (who is subscribed to which feed). The database 621 may also include feed popularity information 623 which it can collect, and other information associated with web feeds but not included in the web feed entries themselves such as topic hierarchy information 625.

The web feed reader 620 exposes an API 624 for getting the stored information 622, 623, 625 which is used by a search engine 630.

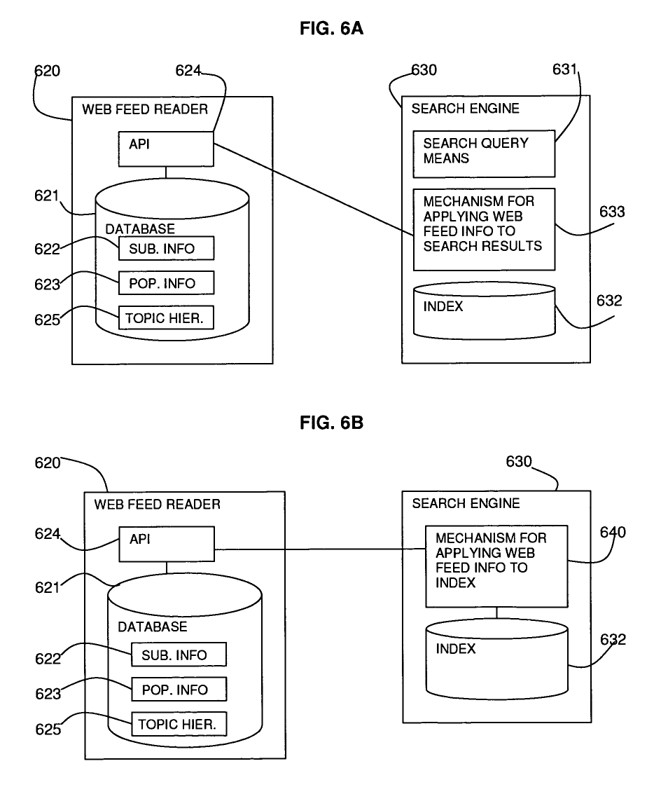

The two sub-embodiments relate to the operation of the search engine 630 in processing the information 622, 623, 625. The distinction between the two sub-embodiments of FIGS. 6A and 6B is whether all web feed reader information is stored at indexing time, or some information is used externally at query time and not stored in the index. In particular, feed popularity and feed subscribers may or may not be indexed.

In the first sub-embodiment shown in FIG. 6A, a search engine 630 post processes results at search time, optionally using the information 622, 623, 625 from the web feed reader 620 at search runtime. The search engine 630 includes a search query means 631 which returns the results of a query from the search engine's index 632. A further mechanism 633 is provided in the search engine 630 for applying the information 622, 623, 625 from the web feed reader 620 to the document results of the search query means 631.

Upon search, search results are returned by the search engine 630. Then, a second stage takes place to influence the results by using the subscription information 622, the feed popularity information 623, and/or the topic hierarchy information 625, all obtained from the web feed reader 620.

In one example, this may include re-ranking results such that popular feeds appear higher, or documents referenced by same feed (topic) are grouped together.

In another example, if it is desired to rank higher documents which are referenced by feeds the user is subscribed to, then the implementation could get that list of feeds from the web feed reader and apply it to the results. If the document has already been enhanced with feed information before indexing, the document will be indexed with the feed(s) referring to it. This method can identify resources referenced by feeds a user has subscribed to and rank those resources higher.

In the second sub-embodiment shown in FIG. 6B, a search engine 630 uses the information 622, 623, 625 from the web feed reader 620 at indexing time. The search engine 630 includes an index 632. A mechanism 640 is provided to add to the index 632 the user subscription information 622, feed popularity information 623, and/or topic hierarchy information 625 from the web feed reader 620.

For example, in this sub-embodiment, each resource may be indexed with users which are subscribed to a web feed which references the resource (for example, by appending fields to the document containing the information), and thus this information can be taken into account in the first stage of producing the results and ranking by the search engine, without the need to have a second stage interacting with the reader once the results are obtained.

Another example is setting a static score to the documents which is a function of the popularity of the feeds referring to them (and optionally other parameters as used by the search engine). This static score will affect the score computed by the search engine of each document upon query time, using common search engine mechanisms.

Methods of enhancing information retrieval using web feed information are described. The overall method obtains web feed information relating to a resource referenced in a web feed and provides the web feed information for access by a search engine to improve information retrieval of the resource.

Obtaining web feed information may be done in various different ways and may include obtaining web feed entry information, metadata of a web feed, and optionally web feed reader information such as subscription information. Similarly, providing the web feed information for access by a search engine may be done at different times and in different ways.

Some embodiments, of the described methods are provided with reference to flow diagrams. It should be noted that a combination of different methods could be used.

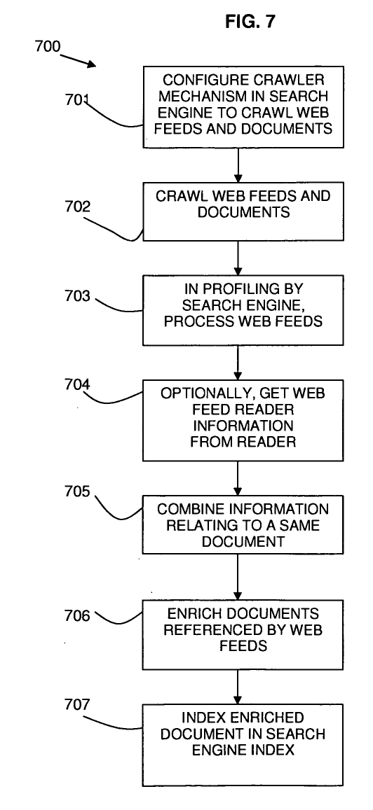

Referring to FIG. 7, a flow diagram 700 shows an embodiment using a search engine to crawl web feeds. A crawler mechanism in a search engine is configured 701 to crawl web feeds along with documents the web feeds refer to. The crawler mechanism crawls 702 the web feeds and the documents. Upon profiling by the search engine, the web feeds are processed 703. Optionally, web feed reader information such as feed popularity, topic hierarchy, or feed subscribers is also be obtained 704 from the web feed reader using its API. Web feed information relating to a same document is combined 705. The documents referenced are enriched 706 with the information from the web feeds and optionally from the web feed reader. The enriched documents are indexed 707 in the search engine index.

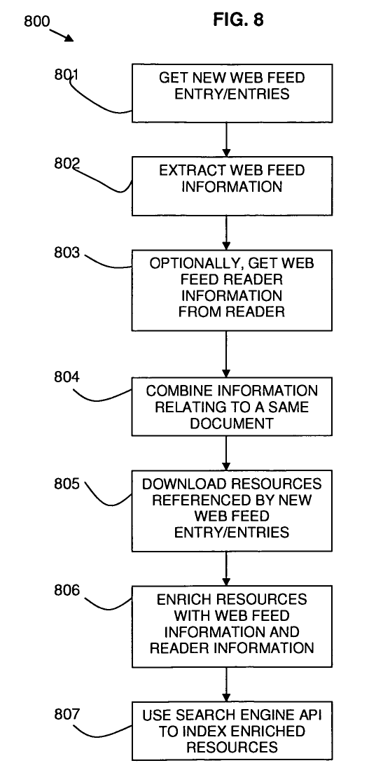

Referring to FIG. 8, a flow diagram 800 shows an embodiment using a web feed reader with a listener component to receive updates of web feeds. The listener component gets 801 a new web feed entry or a group of new feed entries from the web feed reader. The web feed information is extracted 802 from the web feed entry/entries. Optionally, web feed reader information such as feed popularity, topic hierarchy, or feed subscribers is also be obtained 803 from the web feed reader using its API. Web feed information relating to a same document is combined 804.

The listener component then downloads 805 the resources referenced by the new feeds and enriches 806 them with extra information deduced from the referring web feed. This includes information existing in the feed entries as well as information about the containing feed (also provided within the feed itself). Optionally, the resources are also enriched with the information obtained from the web feed reader's API.

Once resource profiles have been enriched, the listener component uses 807 search engine APIs in order to index the enriched documents (original document plus more text, more fields, more facets, etc.).

In a hybrid of the methods of FIGS. 7 and 8, a search engine may access the resources and the web feed information obtained by a listener component, by using its crawler application, and the enriching of the resources may be carried out in the profiling step of the search index.

In another alternative, the search engine's crawler will get the web feed information directly from the reader using the reader's API for getting feed latest posts. This will save the need for the crawler to access the web directly. In this scenario, the listener component is not required. The crawler will still need to fetch the referenced documents themselves as they are not stored by the reader.

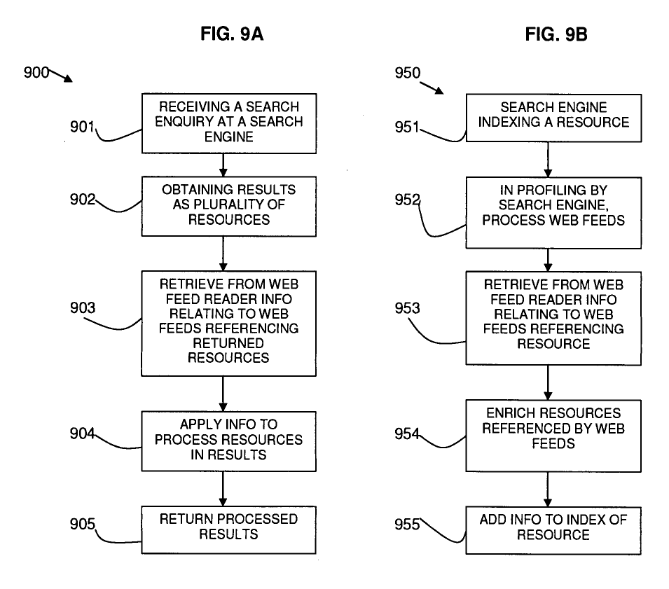

FIGS. 9A and 9B show flow diagrams 900, 950 respectively of methods using web feed reader information to enhance search results.

In FIG. 9A, the flow diagram 900 includes the method at the search engine of receiving 901 a search enquiry and obtaining 902 the results in the form of a plurality of resources. Information relating to web feeds referencing the resources returned in the results is retrieved 903 from the web feed reader. The information retrieved is applied 904 to process the resources in the results. The processed results are returned 905. It should be noted that some information must be added to the documents at indexing time, such as for each feed, the feed that referred to it, so that subscription information can be applied at search time. Processing may be one of or a combination of the following operations: re-ranking results, filtering results, grouping results (e.g. by using site-collapse mechanism).

In FIG. 9B, the flow diagram 950 includes the method at the search engine of indexing 951 a resource. At the time of profiling by a search engine, web feed information is processed 952. Information relating to web feeds referencing the resource is retrieved 953 from the web feed reader. Resources referenced by web feeds are enriched 954, and the information is added 955 to the index of the resource.

A balance should be maintained of whether to include more data at indexing time (at the price of the index size) or use some data upon query time as a second stage at the price of hurting performance. If the method of FIG. 9A is used, most of the information will get into the index, if not all. The only distinction is whether some information will be deferred to effect results at run-time.

Information of feed subscribers may be applied to search results, e.g. re-rank results based on user interests (documents referred by feeds a user has subscribed to are ranked higher). The requirement is primarily to attach for each document the information of users subscribed to feeds referring it, this one may increase index size significantly and one may choose to leave extracting that information to query time.

Feed popularity information may be applied to documents referred by those feeds. It may be used for effecting ranking by popularity, allowing narrowing search results by popularity, or displaying popularity information along search results. The first may be achieved by using static score mechanism at indexing time or by post processing results at search time. The second requires indexing popularity information as another facet of the document. The third requires indexing popularity information as an extra field or attaching this information at search time. The case of attaching popularity information at indexing time will imply better runtime performance. On the other hand, when using that information at query time, then the information will be more up-to-date as it is obtained from the reader at real-time (query time).

Using the described method and system, search engines are able to use web feeds in order to enrich information on the referenced resource or document and use it in various possible ways. Below are examples of how the web feed information may be used. Other uses may also be possible which have not been described here.

A web feed entry contains metadata of the referenced resource, like publication date, author, categories and so on. Upon indexing the referenced resource, the search engine can add that metadata as well. This will enrich the resource representation (profile) in the index thus improving the retrieval capabilities of the search engine:
The existence of extra metadata enriches the resource's description (profile), which allows the search engine to match it to user query more effectively. The extra metadata could be augmented to the resource text and thus be indexed by the search engine. It could be indexed as plain text or using a mechanism of field-value pairs where appropriate (for example, if there is author information, then index an author field with the author name as a value). This allows fielded search which is very common in search engines.
The added metadata improves browsing capabilities. For instance, in a search engine which provides multi-faceted search, the deduced metadata may be added as additional facets of the resource thus enriching the multifaceted search provided. If the search engine supports multi-faceted search, then the appropriate metadata could be added as a facet of the resource using the mechanism which the search engine supports. For example, author information could be added as a document facet and allow browsing by author.

A web feed has metadata of the feed itself. The feed metadata can be used to enrich each resource with the metadata of the feed as well. Advantages are as for the referenced resource metadata. This can be done as above by adding the metadata as fields/facets/plain text to a resource.

A web feed entry contains a short description of the referenced resource. A search engine can add the description text to the resource text thus enriching the resource description (profile). Additionally, the search engine may give boost to terms in the description. The reasoning is that if site authors found the description to be mostly describing the referenced page, then those terms should have a higher weight. The description can be augmented to the resource text and thus can be indexed. Boosting is done by the search engine mechanism to apply a special boost to indexed information.

A web feed is about some topic; this means that all resources referenced by the same web feed have a common topic. Topics can be added as another category to the referenced resources. In the case where there is a hierarchy defined between different web feeds, a taxonomy may be deduced and used to create a catalogue of the referenced resources. A category is a common mechanism in search engines; one may add a category to a resource based on the topic.

Different entries appearing at the same feed imply that the referenced resources are related to each other (i.e. they have a common topic). This fact can be exploited for search engine grouping and suggestions. For example, in the suggestions case, when a search engine returns some document D matching a query, it will also suggest other documents which were contained in the same feed as D. The suggested documents may be picked based on their publication date (ones posted in the same time range as D). In this case, the feed ID is added as a category or field to the document. This will allow the search engine to retrieve documents belonging to the same feed. Also, publication dates should be added to the document as a field to enable picking documents of the same time range as D.

Results grouping mechanisms (such as site-collapse) may also be used to gather documents contained by the same feed in the result set. In this case, the feed ID information is required as well. Grouping may be applied on the search engine results with or without suggestions.

A web feed entry's publication date may be added to the referenced resource metadata. This information may be exploited in order to implement a time based search which does not exist in current search engines that index web pages. Time based search is a very useful feature. For instance, it allows a search for documents while limiting the results to documents that were published at some defined time range. As before, the publication date may be added as an extra field.

Web feeds have subscribers. In enterprise/central feed aggregators, there is access to the subscribers' information. This information may be exploited in different ways:
A boost can be given to documents referenced by popular feeds and they can be ranked higher within a result set; assuming those documents have a higher interest in the community. This may be achieved using a static score mechanism which takes feed popularity into account when generating a document static score or by post-processing the results at query time.
Search results can be personalized based on information deduced from feed subscribers. For instance, when a user submits a query, rank documents which are referenced by feeds that the user is subscribed to a higher rank; assuming that he has more interest in them.
For a search engine with social search features: accompany a document in a result set with the information on the people who are subscribed to feeds referencing that document. The reasoning is that those people have some interest in the topic the document relates to. The user performing the search may have an interest to interact with those people based on an interest in a common topic.
Feed popularity implies the popularity of the referenced content. In environments where only part of the content may be indexed (e.g. due to resource's limitation), a system may deduce which content to index based on the popularity of the feeds that reference that content.

Resources should be indexed with information relating to the web feeds that reference them. There should be maintained information on what feeds a user is subscribed to and which are the popular feeds. This is maintained by the central web feed reader as described above.

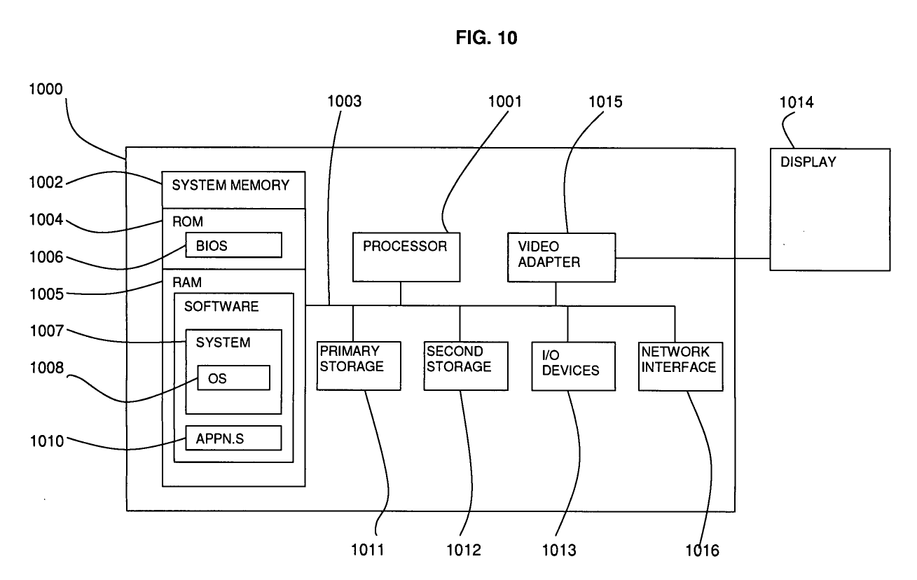

Referring to FIG. 10, an exemplary system for implementing a web feed reader, a listener component, or a search engine, includes a data processing system 1000 suitable for storing and/or executing program code including at least one processor 1001 coupled directly or indirectly to memory elements through a bus system 1003. The memory elements can include local memory employed during actual execution of the program code, bulk storage, and cache memories which provide temporary storage of at least some program code in order to reduce the number of times code must be retrieved from bulk storage during execution.

The memory elements may include system memory 1002 in the form of read only memory (ROM) 1004 and random access memory (RAM) 1005. A basic input/output system (BIOS) 1006 may be stored in ROM 1004. System software 1007 may be stored in RAM 1005 including operating system software 1008. Software applications 1010 may also be stored in RAM 1005.

The system 1000 may also include a primary storage means 1011 such as a magnetic hard disk drive and secondary storage means 1012 such as a magnetic disc drive and an optical disc drive. The drives and their associated computer-readable media provide non-volatile storage of computer-executable instructions, data structures, program modules and other data for the system 1000. Software applications may be stored on the primary and secondary storage means 1011, 1012 as well as the system memory 1002.

The computing system 1000 may operate in a networked environment using logical connections to one or more remote computers via a network adapter 1016.

Input/output devices 1013 can be coupled to the system either directly or through intervening I/O controllers. A user may enter commands and information into the system 1000 through input devices such as a keyboard, pointing device, or other input devices (for example, microphone, joy stick, game pad, satellite dish, scanner, or the like). Output devices may include speakers, printers, etc. A display device 1014 is also connected to system bus 1003 via an interface, such as video adapter 1015.

Although used in the context of web searches, the described systems and methods may equally apply to intranet searches and other non-web searches.

A web feed reader and/or a listener component individually or as part of a search system may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for using web feed information, comprising:
obtaining web feed information relating to a resource referenced in a web feed, wherein web feed information includes at least one of: content of a web feed entry, and information relating to a web feed; and
providing the web feed information relating to the resource for access by a search engine.

2. The method as claimed in claim 1, wherein a search engine uses the web feed information relating to the resource to enhance search retrieval.

3. The method as claimed in claim 2, wherein a search engine applies the web feed information to enrich a resource's representation in a search engine index.

4. The method as claimed in claim 1, wherein the content of a web feed entry includes one or more of the group of: a link to a resource, a description of a resource, metadata of a resource.

5. The method as claimed in claim 1, wherein information relating to a web feed includes one or more of the group of: metadata of a web feed containing a web feed entry, subscribers to a web feed, web feed popularity, topic hierarchy of resources referenced in web feeds, and resources linked by references in the same web feed.

6. The method as claimed in claim 1, wherein obtaining web feed information includes extracting the web feed information from a web feed.

7. The method as claimed in claim 1, wherein obtaining web feed information includes obtaining the web feed information from a web feed reader.

8. The method as claimed in claim 1, wherein obtaining web feed information includes crawling web feeds.

9. The method as claimed in claim 1, wherein providing the web feed information includes providing the web feed information for access by a search engine when indexing resources.

10. The method as claimed in claim 1, wherein providing the web feed information includes providing the web feed information for access by a search engine when processing search query results.

11. The method as claimed in claim 1, including combining web feed information from different web feed entries relating to the same resource.

12. A computer software product for using web feed information, the product comprising a computer-readable storage medium, storing a computer in which program comprising computer-executable instructions are stored, which instructions, when read executed by a computer, perform the following steps:
obtaining web feed information relating to a resource referenced in a web feed, wherein web feed information includes at least one of: content of a web feed entry, and information relating to a web feed; and
providing the web feed information relating to the resource for access by a search engine.

13. A method of providing a service to a customer over a network, the service comprising:
obtaining web feed information relating to a resource referenced in a web feed, wherein web feed information includes at least one of: content of a web feed entry, and information relating to a web feed; and
providing the web feed information relating to the resource for access by a search engine.

14. A system for using web feed information, comprising:
a processor;
means for obtaining web feed information relating to a resource referenced in a web feed, wherein web feed information includes at least one of: content of a web feed entry, and information relating to a web feed; and
means for providing the web feed information relating to the resource for access by a search engine.

15. The system as claimed in claim 14, wherein a search engine uses the web feed information relating to the resource to enhance search retrieval by applying the web feed information to enrich a resource's representation in a search engine index.

16. The system as claimed in claim 14, wherein means for obtaining web feed information includes means for extracting the web feed information from a web feed.

17. The system as claimed in claim 14, wherein means for obtaining web feed information includes means for obtaining the web feed information from a web feed reader.

18. The system as claimed in claim 14, wherein the means for obtaining web feed information is a search engine crawler.

19. The system as claimed in claim 14, wherein the means for providing the web feed information is a search engine index.

20. The system as claimed in claim 14, wherein the means for providing the web feed information is a search engine push interface.

21. The system as claimed in claim 14, wherein means for providing the web feed information includes: an interface for providing the web feed information for access by a search engine when indexing resources.

22. The system as claimed in claim 14, wherein means for providing the web feed information includes: an interface for providing the web feed information for access by a search engine when processing search query results.

23. The system as claimed in claim 14, including means for combining web feed information from different web feed entries relating to the same resource.

24. A method for using web feed information, comprising:
obtaining web feed information relating to a resource referenced in a web feed, wherein web feed information includes at least one of: content of a web feed entry, and information relating to a web feed;
applying the web feed information to enrich a resource's representation in a search index.

25. A search engine comprising:
means for obtaining web feed information relating to a resource referenced in a web feed, wherein web feed information includes at least one of: content of a web feed entry, and information relating to a web feed; and
a profiling module applying the web feed information to enrich a resource's representation in a search index.
